(19) United States
(12) Patent Application Publication
(10) Pub. No.: US 2015/0087398 A1
(43) Pub. Date: Mar. 26, 2015

(54) Game Site Monetization Method

(71) Applicants: William Eun Sae Steinkraus, Fort Lee, NJ (US); Dongyun Kyle Hahn, Fort Lee, NJ (US)

(72) Inventors: William Eun Sae Steinkraus, Fort Lee, NJ (US); Dongyun Kyle Hahn, Fort Lee, NJ (US)

(21) Appl. No.: 14/038,048

(22) Filed: Sep. 26, 2013

(51) Int. Cl. G07F 17/32

(52) U.S. Cl. CPC G07F 17/3244
USPC 463/25

(57) ABSTRACT

A method for monetizing on-line games played on a network game site. The method includes at least one game playable on a mobile device by a player who agrees to accept one or more advertisements predetermined intervals of play, presentation of said advertisements providing a potion of the income of said game site, and the game including a token reward system for each interval of play, the tokens accumulating to a redeeming value that can be redeemed on the network for cash credit or a gift card of specified face value. The token reward system includes at least one player purchase value, less than the redeeming value, at which the player may obtain a cash credit or a gift card of said face value at a price that is discounted from its face value.

### BACKGROUND OF THE INVENTION

The invention relates to a method for monetizing on-line games played on a network game site.

On-line game providers have essentially two income sources. Income from players and/or income from advertisers.

Advertisement has the problem that player tolerance levels for advertisements vary widely. Furthermore advertisers pay substantially more for targeted adds, i.e. ones directed to their selection of criteria and there is a risk that if point-to-cash ratio is are set high enough to be affordable to the site provider the game will only attract a narrow ranger of players (e.g. adolescents who live in their parents basement playing the game 20 hrs a day. Not many advertisers have such people as target audiences.) A player pool should be broad based to attract advertisers and at the same time should provide enough personal information to allow targeting of ads within that pool.

Charging players for on-line play also has its problems. Except in very rare instances of high popularity, few players are willing to pay much if anything to play most games. To increase play, multiple levels can be provided so that users can have varied experiences and player achievement can be tracked with points. In some very popular games points or other virtual rewards can be traded and secondary markets of players have developed with players paying other players for the points or other reward. This again is rare.

Other methods of reward that have been used, or proposed, involve coupons, cash credit or gift cards. Coupons can also be used but expiration dates and their limited scope significantly limit their attractiveness to game players. Cash credit incentives are very difficult since they add substantially to the cost of providing an on-line game platform and it is very difficult to find a formula to profitability. Gift cards have the same problem as cash credits.

US 20110039622, US 20110201415, US20110212762, US20110217681A1, US20110230256, US20110230732, US20120015714, US20120166265A1, US20120202600A1, US20120265604A1, US20120271770A1 are considered background to the invention and are incorporated herein by reference in their entirety.

An on-line platform site is needed that attracts a broad player base, about which the platform provider has substantial detailed information useful for providing targeted advertisements, and at the same time provides a low enough cost base for player rewards to allow profit to the site provider.

### SUMMARY OF THE INVENTION

A method for monetizing on-line games played on a network game site comprising:

at least one game playable on a mobile device by a player who agrees to accept one or more advertisements predetermined intervals of play, presentation of said advertisements providing a potion of the income of said game site,

the game including a token reward system for each interval of play, the tokens accumulating to a redeeming value that can be redeemed on the network for cash credit or a gift card of specified face value; wherein

the token reward system includes at least one player purchase value, less than the redeeming value, at which the player may obtain a cash credit or a gift card of said face value at a price that is discounted from its face value.

### DETAILED DESCRIPTION OF PREFERRED EMBODIMENTS

The player purchase value(s) allows tuning of the ratio of reward for achievement (e.g. skill levels succeeded or random jackpots) and an individual players advertisement tolerance. Unlike coupons, gift cards (or cash credit) provide broad appeal. Since almost everyone recognizes some value in obtaining cash credit or a gift card at a price below the face value the discounts offered can be tailored to maintain a broad player base. Players will have higher advertisement tolerance if the reward for play is seen as valuable to them. At the same time the costs/per player of providing rewards perceived to be valuable enough to accept advertising are reduced by having the player pay a portion of that cost.

Different types of games attract different types of players. For purposes of this application the group of players attracted to play a particular game is termed a “player audience.”

“Target advertising” refers to advertising that is directed to particular individuals based on a selection of personal information about the individual. A collection of data relating to an individual player and collected by a site is referred to as a “personal information profile.” Advertisers pay substantially higher rates when they can deliver ads to individuals that that they believe fits a desired profile. Personal information may include location, age, education level, as will as information about an individuals previous interaction with a site. An example of previous interactions includes the types of games played, purchasing histories, searches conducted and the like.

Different player audiences present different combination of personal information profiles that advertisers consider desirable for particular products. A site may chose a game selection that fits its player audiences to correspond to its advertisers requirements. Alternatively the site may chose to provide a wide variety of player audiences to expand the personal information profile data sets offered to advertisers and from which the advertiser selects individuals for target advertising.

The game may be provided to the mobile device either as a “native” or a web format. In the native format an app downloaded to the device uses resources of the device to provide enhanced experiences, for instance suggestions for gift card selection based on gpc location data and the like. Individual game data may also transferred at the initiation of a game play and then computing functions of the device are used to provide the game experience to minimize data transfer.

In a web format the mobile device functions mostly as a browser. Once user login data is obtained, a web server provides much of the calculation during play. Data transfer may be primarily just screen shots with interactive links. In such applications the data transfer requirements may be substantially higher, which can be a problem for players using mobile devices on services that charge based on data usage.

Of course distribution of calculations between device and server will invariably be a mixture in any format and the game provider may chose to provide play options in only one, or even more than two formats without departing from the invention.

Format offerings may be adjusted to provide enhancement (e.g. in play speed or visuals) in exchange for a player's grant of access to specific personal information or device resources from which personal information can be gathered.

The following additional features can optionally be included, individually or in combination.

In some embodiment the games are provided free to the player. This allows games of chance as well as games of skill to be offered legally. Games of chance have a large player audience, but legal restrictions on on-line gambling are substantial. On-line wagering is banned in many jurisdictions. Free play eliminates wagering, while tapping into the wide popularity of popular wagering games. On-line versions of scratch off games, slot machines, poker, Kino, baccarat, 21 and the like are a few examples. While there are many sites that offer such games for free, usually financed by required viewing of one or more advertisements, the applicants are not aware of any that allow enough players to obtain realistic financial reward to make the games interesting to a wide audience of players. The invention provides an incentive structure that can afford to reward a wide audience and therefore will be much more attractive to advertisers.

Every player receives tokens for each game played, regardless of game outcome. This, coupled with the discount feature, will enhance player loyalty, keep many more players coming back to the time for extended times.

An individual game can be a game of chance, a game of skill, or a combination of skill and chance. Games of chance have the advantage that they are attractive to a large player audience, the odds of winning jackpots are independent of who chooses to play, and those odds can be adjusted to produce a predetermined cost per play. Games of skill tend to attract a narrower audience, and cost per play is less predictable, but in at least some instances it is expected that the cost per play can be realistically predicted and that the player audiences will differ in ways that are attractive to advertisers. Combinations of games offer the game site the opportunity to tailor the evolution over time of its player base to improve fit the needs of its advertisers.

In some embodiments the player provides profile information upon enrollment that allows targeting of the ads provided to that player. This information may include name, address, age and the like, that may not be stored on the device in a manner accessible to the site.

In some embodiments multiple gift cards are offered. Providing a selection is seen to be an important feature of the attractiveness of gift cards in the economy as a whole and it may be very important to a commercially successful implementation of the invention. The specific selection, or gifting of one card may also provide an additional marketing opportunity prompting one or more further targeted ads. If a marketer knows that someone has just obtained an on-line gift card for their products they can expect that that person has some loyality to their brand and may want to encourage that loyalty with further incentives.

There are already gift card vendor sites that allow purchase of a wide selection of cards. Examples include Gift Card Mall, https://www.giftcardmall.com; Plastic Jungle, https://www.plasticjungle.com/main; CardPool, http://www.cardpool.com/ and Gift Card Granny, http://www.giftcardgranny.com/.

In some implementations of the invention the Game Site may interactively link with such a gift card vendor site to provide the gift card purchase. For instance as a result of a player's winning a jackpot or, after earning sufficient tokens and choosing to purchase a gift card by paying a player player purchase value, an application interface may redirect the player to a third party gift card vendor, provide for purchase and payment by the game site using the players selection, and then deliver to the players account at the Game Site. In such embodiments, preferably the application interface returns the player to the Game Site upon selection of the card. In some alternative embodiments the site may itself may enter into distribution agreements with retailers for some or all of the gift cards to be offered for sale through the site.

In some embodiments the player purchase value and the redeeming value are set to encourage the large majority of players to utilize the discounted card. In fact, in at least some embodiments the game site will market itself to prospective players as a way to receive discounts on gift cards. Such campaigns will be expected to be most effective as seasonal gift days approach. Christmas, New Years day, Valentines day, Fathers day, and the like, are examples of such days commonly observed in the United States.

In some embodiments the tokens can be traded, gifted, or donated. This will increase the likelihood that prospective players will value accumulation of tokens and is expected to broaden the base of players available to the advertisers. It is expected that token transfers will also produce secondary marketing exposures of the site, for instance if a charitable organization accumulates tokens it may offer contributors lotteries for the accumulated tokens.

In some embodiments the number of games offered, or offered free, in a specific interval of time can be limited (e.g. 5 games/day/player), to preclude players from increasing their individual cost to the site simply by playing more games in that time interval. This option should help to maintain advertiser interest in the player pool. It is expected that this option should also reduce player burnout, at least if at the same time the range of games offered changes on a regular basis.

Many of these options add to the cost per play. However, at least some will be affordable because the discount offered to the user for the gift card can be adjusted as needed to accommodate the cost.

Games may be offered for play as “native” or web-format.

Play can be programmed to begin play before the advertisement is provided. In one example, the game has a first stage before the advertisement. If the play results in a jackpot the advertisement is displayed on the device, and then after the advertisement has completed, a screen displaying the amount won and procedures for redemption is displayed. If the player loses the first round the player is given a click button to play a bonus round. The advertisement is presented when the bonus button is clicked. In at least some embodiments tokens are only awarded when the bonus button is clicked.

Further costs may be incurred when the gift card is purchased via a mobile device. Depending on the site these costs may be managed using appropriate algorithms to predict the ratio of web format vs native device purchasers or by changing the number of tokens required to obtain a specific award, depending on whether the player accesses the site via web format or native application interfaces. In some embodiments players may be directed from native to web format interfaces in order to facilitate redemption of an award.

The skilled person can implement various aspects of the invention in various ways and with a wide variety of types of games, accounting systems, application interfaces and the like. Further reference in this regard is made to the documents which have been incorporated herein by reference in their entirety.

The following is a non-limiting example of implementation of some aspects of the invention.

### EXAMPLES

The Game Site provides “scratch off” games as play options. The Game Site will provide five scratch off games for the player to have an opportunity to win 100-500 tokens each day. In order to receive a $10 gift card coupon number, the players need to allocate 10,000 tokens. Once the coupon number is provided for the player, the player will be able to make a gift card purchase of their choosing on their native app or website.

Scratch off games provide 100-500 tokens per game. Tokens are randomly awarded according to preset odds. A small number of games, also determined randomly according to preset odds, may provide a Jackpot of 10,000 tokens.

There are only 5 scratch off games per day. They have to play all 5 games in order to receive a new package of 5 scratch off games.

After each scratch off game, the player will have to see an advertisement. They can exit out if they want by pressing the X button on the top left or right.

Using the Apple®'s rewards framework, or a web implemented purchase format, such as Paypal®, the Game Site will provide players the ability to purchase tokens with real currency. E.g. the users can purchase 1000 tokens for 0.99 cents and so forth.

The reason why players would be attracted to refer to this solution is because of this scenario:

Lets say, a user allocated 6,000 tokens with playing games and watching advertisements. If it costs 10,000 tokens for $10 dollar gift card, the user could just purchase 4,000 tokens for $3.99 and receive the gift card coupon number for the $10. This means the user will be actually buying a $10 coupon for 3.99.

The user will need to play 20 games if they win 500 tokens to reach 10,000 tokens. That means they will have to see 20 advertisements. 20 ads=$20 dollars for the Game Site if each advertisement pays Game Site $1 per ad.

Gift card purchase in a is exemplified as follows:
1. User (player or transferee) will log in with their Game Site credentials using a Website or Native application.
2. User will access the Purchase button (link) to access the diverse retailers where the user can purchase gift cards.
3. The user will be able to choose a retailer (e.g. Target®, Amazon®, and/or Starbucks®) to purchase a $10-$250 dollar gift card.
4. The user will need to provide their credit card information or Paypal® credentials to complete the purchase process. The user will receive a receipt of their purchase to their email and notification on the native application of the purchase.

The user will be able to receive a notification on the native application in a “MY CARDS” section. The message will say “You just purchased a $-- (Target®, Amazon®, and/or Starbucks®) gift card!”

These purchased cards will be uploaded into their My cards section and a Pay now section. Each new card will be presented with a bow with the verbiage “new” to indicate the new gift card.

The user will now be able to purchase with this gift card.

Each user will be able to invite new members to become a Game Site member. Each new Game Site member they invite will reward the user with 50 Tokens.

The above examples and disclosure are intended to be illustrative and not exhaustive. These examples and description will suggest many variations and alternatives to one of ordinary skill in this art. All of these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of written description, any dependent claim which follows should be taken as alternatively written in a multiple dependent form from all claims which possess all antecedents referenced in such dependent claim.

1. A method for monetizing on-line games played on a network game site comprising:
at least one game playable on a mobile device by a player who agrees to accept one or more advertisements predetermined intervals of play, presentation of said advertisements providing a potion of the income of said game site,
the game including a token reward system for each interval of play, the tokens accumulating to a redeeming value that can be redeemed on the network for cash credit or a gift card of specified face value; wherein
the token reward system includes at least one player purchase value, less than the redeeming value, at which the player may obtain a cash credit or a gift card of said face value at a price that is discounted from its face value.

2. The method according to claim 1 wherein every player receives points for each game played, regardless of game outcome.

3. The method according to claim 1 wherein the game is a game of chance, a game of skill, or a combination of skill and chance.

4. The method according to claim 1 wherein the player provides profile information upon enrollment that allows targeting of ad.

5. The method according to claim 1 wherein multiple gift cards are offered, the selection of one card prompting one or more further targeted ads.

6. The method according to claim 1 wherein the player purchase value and the redeeming value are set to encourage the large majority of players to utilize the discounted card.

7. The method according to claim 1 wherein the points are allowed be traded, gifted, or donated among accounts at the Game Site.

8. The method according to claim 1 wherein the number of games offered in a specific interval of time is limited to a fixed number.

9. The method according to claim 1 wherein a package of games comprising a plurality of games and associated advertisements are downloaded to the player's mobile device and the player is required to complete the package of games and advertisements before additional games are provided to the player.

10. The method of claim 1 wherein the Game Site maintains a database of personal information relating to each player.

11. The method according to claim 10 wherein the Game Site uses resources on the mobile device to track and report personal information to the Game Site.
